(19) United States
(12) Patent Application Publication
(10) Pub. No.: US 2020/0200106 A1
(43) Pub. Date: Jun. 25, 2020

(54) SYSTEM AND METHOD FOR DETERMINING COMBUSTION PROPERTIES OF A FUEL GAS

(71) Applicant: SCANIA CV AB, Södertälje (SE)

(72) Inventor: Ola STENLÅÅS, Södertälje (SE)

(73) Assignee: Scania CV AB, Södertälje (SE)

(21) Appl. No.: 16/619,727

(22) PCT Filed: Jun. 4, 2018
(86) PCT No.: PCT/SE2018/050573

§ 371 Date: Dec. 5, 2019

(30) Foreign Application Priority Data
Jun. 22, 2017 (SE) 1750804-5

(51) Int. Cl. F02D 33/00; F02M 65/00

(52) U.S. Cl. CPC F02D 33/003; F02M 65/00

(57) ABSTRACT

The invention determines at least one combustion property of a two-phase fuel gas. The invention comprises providing the fuel gas from substantially only a first phase of the fuel gas to a combustion engine and operating the combustion engine such that a first λ-value is achieved in the combustion process. The invention further provides the fuel gas from substantially only a second of the two phases of the fuel gas to the combustion engine, wherein the second phase is different from the first phase and wherein the same volumetric air/fuel ratio is kept as when the combustion engine was operated with the first λ-value. The invention determines a second λ-value when the combustion engine is operated with the fuel gas from substantially only the second of the two phases of the fuel gas and determines at least one first combustion property of the fuel gas based on the second λ-value.

### CROSS-REFERENCE TO RELATED APPLICATIONS

This application is a national stage application (filed under 35 § U.S.C. 371) of PCT/SE2018/050573, filed Jun. 4, 2018 of the same title, which, in turn, claims priority to Swedish Application No. 1750804-5 filed Jun. 22, 2017; the contents of each of which are hereby incorporated by reference.

### FIELD OF THE INVENTION

The present disclosure relates to a method for determining at least one combustion property of a two-phase fuel gas. The present disclosure further relates to a system for determining combustion properties of a two-phase fuel gas, to a vehicle, a computer program product, and a computer-readable medium.

### BACKGROUND OF THE INVENTION

Vehicles operated on fuel gas instead of petrol are becoming increasingly more popular. When operating a vehicle on petrol, the properties of the petrol sold at petrol stations are standardized and one can expect the petrol from different petrol stations and/or sold on different dates to vary only in a predictable way in its properties and compositions. This situation is, however, different for fuel gases. The composition and the combustion properties of fuel gas can vary to a vast amount when compared to petrol. Due to this variation, a combustion engine optimized for operation with a specific composition of fuel gas would in general not operate optimal when being supplied with a fuel gas of another composition. Operating the combustion engine in a non-optimal manner might increase operating cost as this might cause higher fuel consumption, increased wear of the combustion engine, and/or increased exhaust of potentially environmental damaging exhaust gases.

There is thus a need to know what kind of fuel gas is used in a combustion engine. One solution might be to develop a dedicated gas sensor to determine the properties of the fuel gas. This could, however, increase complexity and costs when building and developing vehicle. There is thus a need for determining combustion properties of a fuel gas without requiring a dedicated fuel gas sensor.

### SUMMARY OF THE INVENTION

It is thus an objective of the present disclosure to present a method, a system, a vehicle, a computer program product, and a computer-readable medium for determining combustion properties of a two-phase fuel gas which does not require a dedicated gas sensor.

It is a further objective of the present disclosure to present a method, a system, a vehicle, a computer program product, and a computer-readable medium for determining combustion properties of a two-phase fuel which is less complex/costly.

It is a further objective of the present disclosure to present an alternative method, an alternative system, an alternative vehicle, an alternative computer program product, and an alternative computer-readable medium for determining combustion properties of a two-phase fuel.

At least some of these objectives are achieved by a method for determining at least one combustion property of a two-phase fuel gas. The method comprises the step of providing the fuel gas from substantially only a first of the two phases of the fuel gas to a combustion engine. The method further comprises the step of operating the combustion engine in such a way that a first A-value is achieved in the combustion process. The method even further comprises the step of providing the fuel gas from substantially only a second of the two phases of the fuel gas to the combustion engine, wherein the second phase is different from the first phase and wherein the same volumetric air/fuel ratio is kept as when the combustion engine was operated with the first A-value for the first phase. The method also comprises the step of determining a second λ-value when the combustion engine is operated with the fuel gas from substantially only the second of the two phases of the fuel gas. The method also comprises the step of determining at least one first combustion property of the fuel gas based on the second A-value.

This determining of the combustion property/properties has the advantage that only components already present in state of the art vehicles are used. Especially A-sensors are present in basically all vehicles. Thus, the method can easily be implemented in existing vehicles. Further, the low number of involved components facilitates a robust method.

In one example the at least one first combustion property relates to the energy content of the fuel gas and/or the knocking properties of the fuel gas. These are important properties for a combustion process and knowing them allows for improving environmental properties of the combustion process and/or the feeling the vehicle behaves for a driver.

In one example the method further comprises the step of determining a first set of possible compositions of the fuel gas based on the second A-value. Knowing the compositions allows for specific adaptions in the combustion process.

In one example the first phase is a gaseous phase and the second phase is a liquid phase.

In one example the method further comprises the step of determining a pressure in a fuel gas tank which comprises the two-phase fuel gas and determining a temperature in said fuel gas tank which comprises the two-phase fuel gas. This allows for further and/or more precise adaptions.

In one example the method further comprises the step of determining a ratio between methane and higher hydrocarbons based on the determined temperature and based on the determined pressure. This allows for further determining possible compositions of the fuel gas.

In one example the method further comprises the step of determining a second set of possible compositions of the fuel gas based on the determined temperature and based on the determined pressure.

In one example the method further comprises the step of determining a third set of possible compositions of the fuel gas based on the first set and the second set and/or based on the first set and the ratio between methane and higher hydrocarbons. This allows for further determining possible compositions of the fuel gas.

In one example the method further comprises the step of determining at least one second combustion property of the fuel gas based on the third set of possible compositions. The at least one second combustion property comprises the energy content of the fuel gas and/or the composition of the fuel gas. This allows for more detailed and/or more accurate determinations and/or adaptions.

In one example the method further comprises the step of adapting an engine control of the combustion engine based on the at least one first combustion property and/or based on the at least one second combustion property. This can reduce environmental effects from the combustion process and/or improve engine characteristics and/or improve driveability for an operator of the vehicle.

At least some of the objectives are also achieved by a system for determining combustion properties of a two-phase fuel gas. The system comprises means for providing the fuel gas from substantially only a first of the two phases of the fuel gas to a combustion engine. The system also comprises means for operating the combustion engine in such a way that a first A-value is achieved in the combustion process. The system further comprises means for providing the fuel gas from substantially only a second of the two phases of the fuel gas to a combustion engine, wherein the second phase is different from the first phase and wherein the same volumetric air/fuel ratio is kept as when the combustion engine was operated with the first A-value for the first phase. The system even further comprises means for determining a second A-value when the combustion engine is operated with the fuel gas from substantially only the second of the two phases of the fuel gas. The system also comprises means for determining at least one first combustion property of the fuel gas based on said second A-value.

In one embodiment the system further comprises means for determining the pressure in a fuel gas tank comprising the two-phase fuel gas tank, and means for determining the temperature in said fuel gas tank comprising the two-phase fuel gas tank.

At least some of the objectives are also achieved by a vehicle comprising the system according to the present disclosure.

At least some of the objectives are also achieved by a computer program product comprising instructions which, when the program is executed by a computer, cause the computer to carry out the method according to the present disclosure.

At least some of the objectives are also achieved by a computer-readable medium comprising instructions which, when executed by a computer, cause the computer to carry out the steps of the method according to the present disclosure.

The system, the vehicle, the computer program product, and the computer-readable medium have the corresponding advantages as the corresponding examples of the method.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, a system according to one embodiment of the present invention;

FIG. 3 shows, in a schematic way, a flow chart over an example of a method according to the present invention;

FIG. 4a-c show different relations and/or measurement results as they might be observed in relation to the present disclosure; and

FIG. 5 shows, in a schematic way, a device which can be used in connection with the present invention.

### DETAILED DESCRIPTION OF THE INVENTION

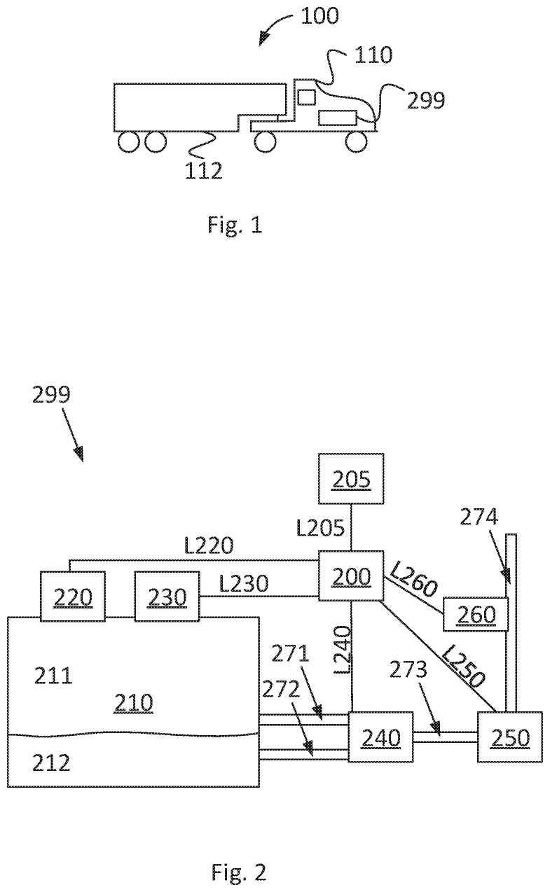

FIG. 1 shows a side view of a vehicle 100. In the shown example, the vehicle comprises a tractor unit 110 and a trailer unit 112. The vehicle 100 can be a heavy vehicle such as a truck. In one example, no trailer unit is connected to the vehicle 100. The vehicle 100 comprises an internal combustion engine. The vehicle comprises a system 299 determining combustion properties of a two-phase fuel gas. This is described in more detail in relation to FIG. 2. The system 299 can be arranged in the tractor unit 110.

In one example, the vehicle 100 is a bus. The vehicle 100 can be any kind of vehicle comprising an internal combustion engine. Other examples of vehicles comprising an internal combustion engine are boats, passenger cars, construction vehicles, and locomotives.

The term “link” refers herein to a communication link which may be a physical connection such as an opto-electronic communication line, or a non-physical connection such as a wireless connection, e.g. a radio link or microwave link.

FIG. 2 depicts, in a schematic way, an embodiment of a system 299 for determining combustion properties of a two-phase fuel gas. It should be emphasized that not all elements in FIG. 2 are needed for performing the present disclosure. Instead, the elements described in relation to FIG. 2 are chosen so that different possible embodiments with different corresponding advantages can be discussed.

The system 299 can comprise a fuel tank 210. The fuel tank 210 is arranged to store the two-phase fuel gas. The two-phase fuel gas comprises a first phase and a second phase. The fuel tank 210 is arranged to store the fuel gas in the first phase 211 and in the second phase 212. In a preferred example, the fuel gas has a liquid and a gaseous phase. In one example, the fuel gas is stored in its liquid phase in the fuel tank 210. In one example, the fuel gas is stored in its gaseous phase in the fuel tank 210. An example of a two-phase fuel gas is so-called Liquefied Natural Gas, LNG. However, the present disclosure can be adapted to any other two-phase fuel gas as well. The term two-phase fuel gas relates to the fact that the fuel gas will be present to more than a marginal fraction in at least two-phases when stored in the vehicle. In the following the term “two-phase” will be omitted when referring to the two-phase fuel gas. In one example the first phase is the gaseous phase. In one example the second phase is the liquid phase. In one example the fuel gas is accessible in either of its two phases.

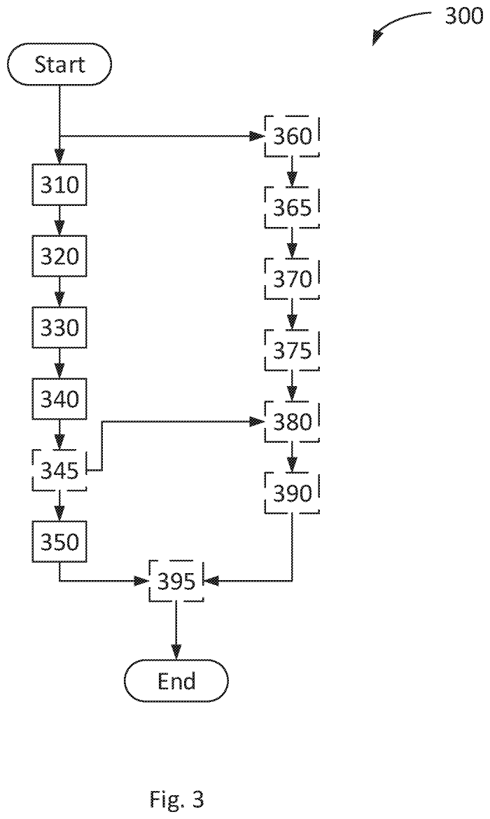

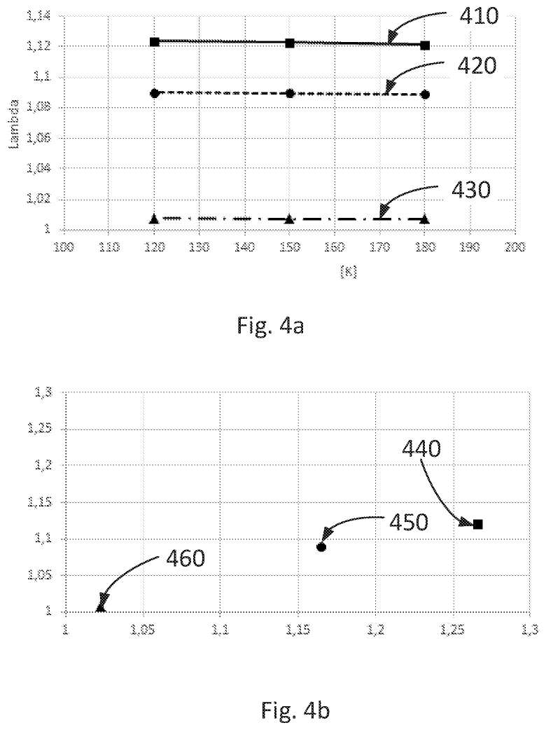

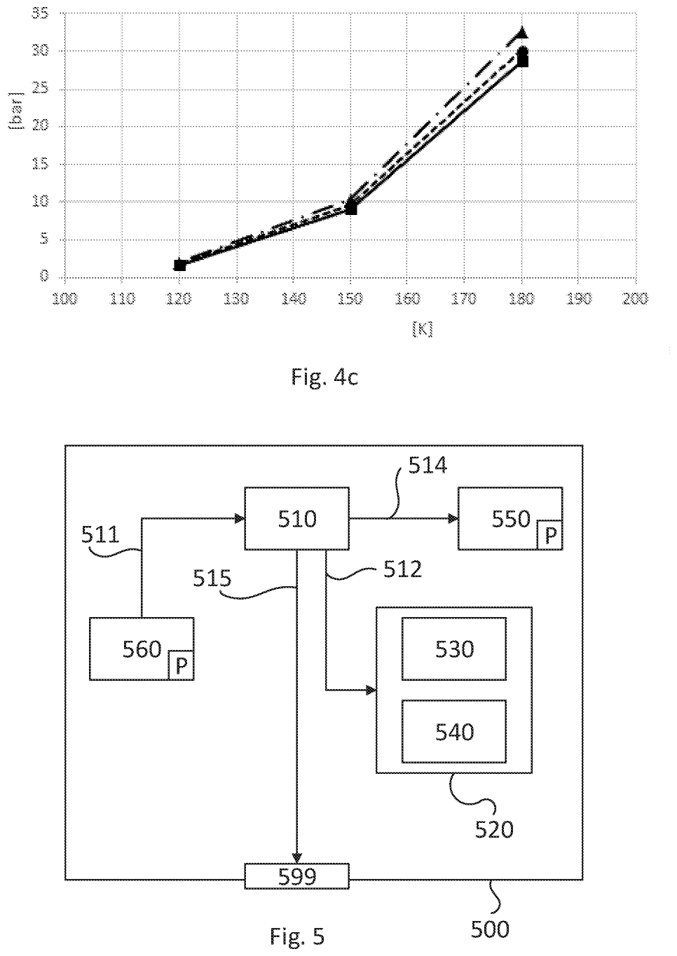

The fuel gas can in principal have different compositions. In one example, the different compositions of the fuel gas can comprise methane, ethane, propane, butane, and/or higher hydrocarbons. The fuel gas can comprise any other components. The composition of the fuel gas will further be discussed in relation to FIG. 3 and FIG. 4a-c.

The system 299 can comprise a passage 271. The first passage 271 is connected to the fuel tank 210. The first passage 271 is arranged to allow transport of the fuel gas in substantially only the first phase from the fuel tank 210.

The system 299 can comprise a second passage 272. The second passage 272 is connected to the fuel tank 210. The second passage 272 is arranged to allow transport of the fuel gas taken from substantially only the second phase from the fuel tank 210. When referring to the transport of the fuel gas from substantially only the second phase from the fuel tank 210 this only refers to from which phase in the fuel tank the fuel gas is taken. It does not necessarily relate to in which phase the fuel gas is then transported in the second passage 272. The second passage 272 can be arranged to convert the fuel gas from the second to the first phase. In one example, the second passage 272 is arranged to vaporize the fuel gas.

The system 299 can comprise a valve arrangement 240. The first passage 271 can be arranged to transport the fuel gas to the valve arrangement 240. The second passage 272 can be arranged to transport the fuel gas the valve arrangement 240. The valve arrangement can be arranged to allow in a first state of operation basically only fuel gas from the first passage 271 to pass the valve arrangement 240. The valve arrangement can be arranged to allow in a second state of operation basically only fuel gas from the second passage 272 to pass the valve arrangement 240.

The system 299 can comprise a first control unit 200. The first control unit 200 can be arranged to control operation of the valve arrangement 240. The first control unit 200 can be arranged to control the valve arrangement in such a way that basically only fuel gas from the first passage 271 is allowed to pass the valve arrangement 240. The first control unit 200 can be arranged to control the valve arrangement in such a way that basically only fuel gas from the second passage 272 is allowed to pass the valve arrangement 240. The first control unit 200 is arranged for communication with the valve arrangement 240 via a link L240.

The system 299 can comprise a third passage 273. The system 299 can comprise an internal combustion engine 250. The third passage 273 can be connected to the valve arrangement 240 and/or the internal combustion engine 250. The third passage 273 is arranged to allow transport of the fuel gas from the valve arrangement 240 to the internal combustion engine 250.

The internal combustion engine 250 is arranged to transport the fuel gas to at least one cylinder of the internal combustion engine 250. The internal combustion engine 250 is arranged to transport air to the at least one cylinder. The internal combustion engine 250 is arranged to combust the mixture of fuel gas and air in the at least one cylinder.

The system can comprise a fourth passage 274. The fourth passage 274 can be arranged to transport exhaust gases from the internal combustion engine 250. The system can comprise means for determining a A-value. In one example the means for determining a A-value comprise a so-called A-sensor 260. In one example, the A-sensor 260 is arranged at the fourth passage 274. The A-sensor 260 is arranged to determine the so-called A-value. The so-called A-value is defined as the ratio between the current air/fuel gas mass-ratio which is supplied to the internal combustion engine 250 and the stoichiometric air/fuel gas mass-ratio of the internal combustion engine 250. A A-value of 1 thus indicates that the internal combustion engine is operated at the stoichiometric air/fuel gas mass-ratio. The A-sensor 260 can be arranged to transmit data to the first control unit 200. The A-sensor 260 is arranged for communication with the first control unit 200 via a link L260. The first control unit 200 can be arranged to determine a A-value based on the data from the A-sensor 260.

The system 299 can comprise means 220 for determining the temperature in the fuel gas tank. The means 220 can comprise a temperature sensor. The means 220 can be arranged for determining the temperature of the fuel gas in the fuel gas tank. The means 220 can be arranged to transmit data to the first control unit 200. The means 220 are arranged for communication with the first control unit 220 via a link L220. The first control unit 200 can be arranged to determine the temperature of the fuel gas in the fuel gas tank 210 based on the transmitted data from the means 220.

The system 299 can comprise means 230 for determining the pressure in the fuel gas tank. The means 230 can comprise a pressure sensor. The means 230 can be arranged for determining the pressure of the fuel gas in the fuel gas tank. The means 230 can be arranged to transmit data to the first control unit 200. The means 220 are arranged for communication with the first control unit 230 via a link L230. The first control unit 200 can be arranged to determine the pressure of the fuel gas in the fuel gas tank 210 based on the transmitted data from the means 230.

The internal combustion engine 250 can be arranged to transmit data to the first control unit 200. The first control unit 200 can be arranged to transmit data to the internal combustion engine 250. The first control unit 200 can be arranged to control operation of the internal combustion engine 250. The first control unit 200 is arranged for communication with the internal combustion engine via a link L250. The internal combustion engine 250 is arranged to receive information from the first control unit 200. The first control unit 200 can be arranged to control the internal combustion engine 250 based on information from the A-sensor 260. The first control unit 200 can be arranged to control the internal combustion engine 250 so that a specific value for A is achieved at the A-sensor 260, such as A=1. This control can comprise changing the air/fuel gas ratio in at least one cylinder of the internal combustion engine 250.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as facilitating heat release evaluation at the reciprocating combustion engine. The innovative method may be conducted by the first control unit 200 or the second control unit 205, or by both of them.

The system 299 can perform any of the method steps described later in relation to FIG. 3.

FIG. 3 shows, in a schematic way, a flow chart over an example of a method 300 for determining at least one combustion property of a two-phase fuel gas. The method can start with step 310.

Step 310 comprises providing the fuel gas from substantially only a first of the two phases of the fuel gas to a combustion engine. This can, for example, be achieved by controlling the valve arrangement 240 so that the valve arrangement 240 only allows the fuel gas present in the first passage 271 to pass or only allows the fuel gas present in the second passage 272 pass. In one example the first phase is the gaseous phase. In one example the first phase is the liquid phase. When referring to the fact that the fuel gas is provided from substantially only a first phase, this does not exclude the possibility that the gas will arrive at another phase at the combustion engine. Thus, in one example the fuel gas is provided from the first phase and arrives at the combustion engine in the second phase. In one example, the fuel gas is provided from the first phase and arrives at the combustion engine in the first phase. In a preferred example, the fuel gas is provided from the liquid phase and arrives at the combustion engine in the gaseous phase. This can, for example, be achieved by vaporizing the fuel gas. The method continues with step 320.

In step 320 the combustion engine is operated in such a way that a first λ-value is achieved in the combustion process. In the following it is assumed that the first λ-value equals 1. However, the disclosure is not restricted to that value and any other first λ-value would be possible as well. It is well known in the art how to operate a combustion engine so that a λ-value of 1 is achieved. Therefore, this is not discussed any further here. In one example step 320 comprises controlling the amount of air in relation to the amount of fuel gas which is injected into at least one cylinder of the combustion engine. The method continues with step 330.

In step 330 the fuel gas is provided from substantially only a second of the two phases of the fuel gas to the combustion engine. This can, for example, be achieved by controlling the valve arrangement 240 so that the valve arrangement 240 only allows the fuel gas present in the first passage 271 to pass or only allows the fuel gas present in the second passage 272 pass. The second phase is different from the first phase which was used in step 310. In one example the second phase is the gaseous phase. In one example the second phase is the liquid phase. When referring to the fact that the fuel gas is provided from substantially only a second phase, this does not exclude the possibility that the gas will arrive at another phase at the combustion engine. Thus, in one example the fuel gas is provided from the second phase and arrives at the combustion engine in the first phase. In one example, the fuel gas is provided from the second phase and arrives at the combustion engine in the second phase. In a preferred example, the fuel gas is provided from the gaseous phase and arrives at the combustion engine in the gaseous phase. In step 330 the same volumetric air/fuel ratio is kept as when the combustion engine was operated with λ=1 for the first phase. Herein the term air/fuel ratio relates preferably to the ratio between air and fuel gas which are injected into at least one cylinder of the combustion engine. This implies in general that the combustion engine is not operated so as to achieve a value of λ=1 for the second phase. The method continues with step 340.

Step 340 comprises determining a second λ-value when the combustion engine is operated with the fuel gas from substantially only the second of the two phases of the fuel gas. In other words, step 340 comprises determining a second λ-value when the combustion engine is operated as in step 330. The first λ-value in step 320 and/or the second λ-value in step 340 can be determined by a λ-sensor, such as the λ-sensor 260 described in relation to FIG. 2. The composition of the fuel gas in the first and in the second phase is in general not the same. This is due to an effect called fractional distillation. Different components of the fuel gas will in general have different boiling temperatures given a specific pressure. Thus, some of the components of the fuel gas will in general occupy a larger fraction of the fuel gas in one phase and a lower fraction of the fuel gas in the other phase. This causes in general the stoichiometric air/fuel gas ratio to differ between the two phases. This in its turn can cause the second λ-value to differ from the first λ-value in case the air/fuel ratio is kept constant. The method can continue with step 345.

The optional step 345 comprises determining a first set of possible compositions of the fuel gas based on the second λ-value.

A simulation example is shown in FIG. 4a, wherein the second λ-value is depicted on the vertical axis and a temperature in the fuel tank is depicted on the horizontal axis. It has to be remembered that all curves 410, 420, 430 depicted in FIG. 4a would cause a first λ-value of 1 in step 320. In the shown example of FIG. 4a the first phase is the gaseous phase and the second phase, i.e. the phase causing the depicted second λ-value, is the liquid phase.

The first curve 410 depicts the situation where the fuel gas consists of 87% methane, 10% ethane, 2.5% propane, and 0.5% butane. As can be seen, the second λ-value of slightly more than 1.12 differs comparably strong to the first λ-value. The second curve 420 depicts the situation where the fuel gas consists of 91.5% methane, 5.5% ethane, 2.5% propane, and 0.5% butane. The second λ-value of approximately 1.09 of the second curve 420 differs less from 1 than second λ-value of the first curve 410. This is due to the fact that the fuel gas for the second curve has a larger fraction of methane among its composition, so that non-methane compositions only occupy a smaller fraction and thus only to a smaller amount can contribute to differing first and second λ-values. The third curve 430 depicts the situation where the fuel gas consists of 99% methane and 1% ethane. As can be seen, the second λ-value of approximately 1.01 of the third curve differs only slightly from the first λ-value. The third curve 430 shows much lower differences between the first and the second λ-value than the first curve 410 and the second curve 420. This is due to the fact that the third curve consists basically only of methane, thus not allowing a huge difference in fuel gas compositions between the first and the second phase of the fuel gas. The figure shows three simulation points in each curve and a linear line connecting them. It can be seen in FIG. 4a that the relevant temperature range in the fuel tank basically has no influence regarding the second λ-value.

Thus, assuming a second λ-value of approximately 1.12 was determined in step 340, one can conclude that the composition described in relation to the first curve 410 is a possible composition of the fuel gas. Similarly, in case a second λ-value of approximately 1.09 was determined in step 340, one can conclude that the composition described in relation to the second curve 420 is a possible composition of the fuel gas. Similarly, in case a second λ-value of approximately 1.01 was determined in step 340, one can conclude that the composition described in relation to the third curve 430 is a possible composition of the fuel gas.

However, in general more than one possible composition of fuel gas would result in a given second λ-value. This can deducably seen from FIG. 4b.

FIG. 4b shows the second λ-value on both of its axis, wherein the vertical axis applies for fuel gas with methane and ethane as main components as in relation to FIG. 4a. Thus, the first point 440 representing a fuel gas composition as in the first curve of FIG. 4a results in the second λ-value of the first curve 410 discussed in relation to FIG. 4a. The second point 450 representing a fuel gas composition as in the second curve of FIG. 4a results in the second λ-value of the second curve 420 discussed in relation to FIG. 4a. The third point 460 representing a fuel gas composition as in the third curve of FIG. 4a results in the second λ-value of the third curve 430 discussed in relation to FIG. 4a.

The horizontal axis applies for fuel gas with the same volumetric methane content for the vertical axis, i.e. as in FIG. 4a, but with butane as main supplement to methane. The first point 440 represents a composition of the fuel gas of 87% methane, 0.5% ethane, 2.5% propane, and 10% butane. This fuel gas composition results in a second λ-value of approximately 1.26-1.27. The second point 450 represents a composition of the fuel gas of 91.5% methane, 0.5% ethane, 2.5% propane, and 5.5% butane. This fuel gas composition results in a second λ-value of approximately 1.16. The third point 440 represents a composition of the fuel gas of 99% methane and 1% butane. This fuel gas composition results in a second λ-value of approximately 1.02. As can be seen, a given amount of methane can give different second λ-values depending on the amount of the other components of the fuel gas.

A corresponding behaviour would be seen with methane and propane as main components instead of methane and butane or ethane as depicted in FIG. 4b. A determined second λ-value will thus in general allow a first set of possible compositions of the fuel gas. The first set of possible compositions can thus comprise a first number of possible combinations. The method continues with step 350.

Step 350 comprises determining at least one first combustion property of the fuel gas based on the second λ-value. In one example the at least one first combustion property comprises the energy content of the fuel gas. In a first approximation the energy content of one unit of the fuel gas scales with the number of carbon-atoms in the unit of the fuel gas. The number of carbon-atoms in the unit of the fuel gas can be approximated as a function of the second λ-value of the fuel gas. Thus, it is possible to derive an approximate value for the energy content of the fuel gas from the second λ-value.

In one example the at least one first combustion property comprises the knocking properties of the fuel gas. The knocking properties relate to the probability that the fuel gas in at least one cylinder of the combustion engine will ignite before the intended point of ignition in the combustion cycle of the combustion engine. This can, for example, appear due to the fact that the pressure inside the cylinder is unintentionally so high that the fuel gas will self-ignite. The threshold pressure for self-ignition in general depends on the fuel gas composition. Such an unintended self-ignition can cause acoustical distortions of the combustion engine, known as knocking, and can drastically reduce the life-time of the motor. Thus, it is advantageous to avoid such knocking in a combustion cycle. In a first approximation the knocking properties of the fuel gas can be related to the number of carbon-atoms in the unit of the fuel gas. The number of carbon-atoms in the unit of the fuel gas can be approximated as a function of the second λ-value of the fuel gas. Thus, it is possible to derive the knocking properties of the fuel gas from the second λ-value. The method can continue with the optional step 395, which will be described further below.

After the start of the method 300 the optional step 360 can be performed. Step 360 comprises determining a pressure in the fuel gas tank which comprises the two-phase fuel gas. The fuel gas tank can be the fuel gas tank 210 described in relation to FIG. 2. The determining of the pressure can be performed by the means 230 and/or the first control unit 200. In one example the pressure in the first phase of the fuel gas is determined. In one example the pressure in the gaseous phase of the fuel gas is determined. The method continues with the optional step 365.

The optional step 365 comprises determining a temperature in the fuel gas tank which comprises the two-phase fuel gas. The fuel gas tank can be the fuel gas tank 210 described in relation to FIG. 2. The determining of the temperature can be performed by the means 220 and/or the first control unit 200. In one example the temperature in the first phase of the fuel gas is determined. In one example the temperature in the second phase of the fuel gas is determined. In one example the temperature in the gaseous phase of the fuel gas is determined. In one example the temperature in the liquid phase of the fuel gas is determined. The method continues with the optional step 370.

The optional step 370 comprises determining a ratio between methane and higher hydrocarbons based on the determined temperature and based on the determined pressure. An example is given in FIG. 4c. The horizontal axis of FIG. 4c denotes the temperature inside the fuel tank. The vertical axis denotes the pressure inside the fuel tank. The symbols for the points and lines in FIG. 4c correspond to the same symbols as introduced in relation to FIG. 4a. Thus FIG. 4c depicts nine simulation points and linear lines between them. The nine simulation points correspond to three different amounts of methane in the fuel gas as introduced in relation to FIG. 4a. The curves between the simulation points can be easily adapted to non-linear curves. Also, easily more simulation results can be entered. The FIG. 4c is thus only for demonstration purposes. As can be seen in FIG. 4c, a combination of pressure and temperature in the fuel tank can determine to which curve the combination belongs. It is thus possible to determine the ratio between methane and higher hydrocarbons based on the determined temperature and measure. As an example, a determined temperature of 180 K and a determined pressure of 30 bar will result in a ratio of 91.5% methane and 8.5% of higher hydrocarbons in the fuel gas. The method continues with the optional step 375.

In the optional step 375 a second set of possible compositions of the fuel gas can be determined based on the determined temperature and based on the determined pressure. This is achieved by the component fraction weighted vapour pressures at the determined temperature and/or total pressure. The method continues with the optional step 380.

In the optional step 380 a third set of possible compositions of the fuel gas is determined based on the first set and the second set and/or based on the first set and the ratio between methane and higher hydrocarbons. In one example the third set is the intersection of the first and the second set. In one example the third set is the intersection of the first set and the ratio between methane and higher hydrocarbons. It should be understood that the intersection does not necessarily have to be performed in a strictly mathematical sense. As physical values always have some uncertainties, it can in one example be decided that a possible composition in one set and one possible composition in another set are the same as long as they do not differ more than a pre-determined threshold. The pre-determined threshold can be absolute and/or relative. The threshold is preferably adapted to the kind of sensors used and to the accuracy of the sensors and/or the calculations done. Preferably the threshold is adapted in such a way that the third set will comprise a small number of elements, wherein the small number is larger than zero. In one example the threshold is adapted so that the third set will comprise only one composition. The method continues with the optional step 390.

In the optional step 390 at least one second combustion property of the fuel gas is determined based on the third set of possible compositions. In one example the at least one second combustion property comprises the energy content of the fuel gas. In one example the at least one second combustion property comprises the composition of the fuel gas. The energy content of the fuel gas can thus be determined in step 390 and/or in step 350. In general, a determination in step 390 will give more accurate results. However, a determination via step 350 might in many cases be enough. The method can continue with the optional step 395.

In the optional step 395 an engine control of the combustion engine is adapted based on the at least one first combustion property and/or based on the at least one second combustion property. The adaption can, for example, comprise anything of adapting the ignition point, adapting the amount of fuel gas inserted during a combustion cycle, adapting exhaust gas recirculation rate, EGR rate, adjusting the intake and/or exhaust valve times on an engine with variable valve actuation, VVA, adapting a variable-geometry turbocharger setting, VGT-setting, in case a VGT is present, adapting engine coolant and/or oil temperature, adapting the proportions of secondary fuel for dual fuel engines, and/or the like. The method ends after the optional step 395.

The method 300 can be performed repeatedly. In one example the method is performed after a certain event. In one example the event is the switching on of the combustion engine. In one example the event is a refuelling of the fuel tank. In one example the method is performed a pre-determined time period after the event occurred. In one example the method is repeated after a certain time interval. The steps of the method 300 can be performed by the elements of the system 299. Actions which have been described in relation to FIG. 2 can be performed during the method 300, for example as part of the steps of the method 300. The method 300 has been described in a specific order. However, the method can be in principle be performed in any other order and/or in parallel.

FIG. 5 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program P comprises routines for determining at least one combustion property of a two-phase fuel gas.

The computer program P may comprise routines for providing the fuel gas from substantially only a first of the two phases of the fuel gas to a combustion engine. This may at least partly be performed by means of said first control unit 200 controlling operation of the valve arrangement 240.

The computer program P may comprise routines for operating (320) the combustion engine in such a way that a first λ-value of 1 is achieved in the combustion process. This may at least partly be performed by means of said first control unit 200 controlling the internal combustion engine.

The computer program P may comprise routines for providing the fuel gas from substantially only a second of the two phases of the fuel gas to the combustion engine, wherein the second phase is different from the first phase and wherein the same volumetric air/fuel ratio is kept as when the combustion engine was operated with λ=1 for the first phase. This may at least partly be performed by means of said first control unit 200 controlling operation of the valve arrangement 240.

The computer program P may comprise routines for determining a second λ-value when the combustion engine is operated with the fuel gas from substantially only the second of the two phases of the fuel gas. This may at least partly be performed by means of said first control unit 200. The second λ-value might be stored in the non-volatile memory 520.

The computer program P may comprise routines for determining at least one first combustion property of the fuel gas based on said second λ-value. This may at least partly be performed by means of said first control unit 200.

The computer program P may comprise routines for determining a pressure in a fuel gas tank which comprises the two-phase fuel gas. This may at least partly be achieved by the first control unit 200 and/or the means 230. The computer program may comprise routines for determining a temperature in said fuel gas tank which comprises the two-phase fuel gas. This may at least partly be performed by means of said first control unit 200 and/or said means 230.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L220, L230, L240, L250, and L260, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

It should especially be noted that the system according to the present disclosure can be arranged to perform any of the steps or actions described in relation to the method 300. It should also be understood that the method according to the present disclosure can further comprise any of the actions attributed to an element of the sensor fusion system 299 described in relation to FIG. 2. The same applies to the computer program and the computer program product.

1. A method for determining at least one combustion property of a two-phase fuel gas, the method comprising:
providing the fuel gas from substantially only a first of the two phases of the fuel gas to a combustion engine;
operating the combustion engine such that a first λ-value is achieved in the combustion process;
providing the fuel gas from substantially only a second of the two phases of the fuel gas to the combustion engine, wherein the second phase is different from the first phase and wherein a same volumetric air/fuel ratio is kept as when the combustion engine was operated to achieve the first λ-value for the first phase of the fuel gas;
determining a second λ-value when the combustion engine is operated with the fuel gas from substantially only the second of the two phases of the fuel gas; and
determining at least one first combustion property of the fuel gas based at least on said second λ-value.

2. The method according to claim 1, wherein said at least one first combustion property relates to an energy content of the fuel gas and/or knocking properties of the fuel gas.

3. The method according to claim 1, further comprising:
determining a first set of possible compositions of the fuel gas based at least on said second λ-value.

4. The method according to claim 1, wherein said first phase of the fuel gas is a gaseous phase and wherein said second phase of the fuel gas is a liquid phase.

5. The method according to claim 1, further comprising:
determining a pressure in a fuel gas tank which comprises the two-phase fuel gas; and
determining a temperature in said fuel gas tank.

6. The method according to claim 5, further comprising:
determining a ratio between methane and higher hydrocarbons in the two-phase fuel gas based at least on said determined temperature and/or based at least on said determined pressure in said fuel gas tank.

7. The method according to claim 5, further comprising:
determining a second set of possible compositions of the fuel gas based at least on said determined temperature and/or based at least on said determined pressure in said fuel gas tank.

8. The method according to claim 6, further comprising:
determining a first set of possible compositions of the fuel gas based at least on said second λ-value;
determining a second set of possible compositions of the fuel gas based at least on said determined temperature and/or based at least on said determined pressure in said fuel gas tank;
determining a third set of possible compositions of the fuel gas based at least on: said first set and said second set of possible compositions of the fuel gas; and/or based at least on said first set of possible compositions of the fuel gas and said ratio between methane and higher hydrocarbons.

9. The method according to claim 8, further comprising:
determining at least one second combustion property of the fuel gas based at least on said third set of possible compositions, said at least one second combustion property comprising an energy content of the fuel gas and/or a composition of the fuel gas.

10. The method according to claim 1, further comprising:
adapting an engine control of the combustion engine based at least on said at least one first combustion property.

11. The method according to claim 9, further comprising:
adapting an engine control of the combustion engine based at least on said at least one first combustion property and/or based at least on said at least one second combustion property.

12. A system for determining combustion properties of a two-phase fuel gas, the system comprising:
means for providing the fuel gas from substantially only a first of the two phases of the fuel gas to a combustion engine;
means for operating the combustion engine in such a way that a first λ-value is achieved in the combustion process;
means for providing the fuel gas from substantially only a second of the two phases of the fuel gas to a combustion engine, wherein the second phase is different from the first phase and wherein a same volumetric air/fuel ratio is kept as when the combustion engine was operated to achieve the first λ-value for the first phase of the fuel gas;
means for determining a second λ-value when the combustion engine is operated with the fuel gas from substantially only the second of the two phases of the fuel gas; and
means for determining at least one first combustion property of the fuel gas based at least on said second λ-value.

13. The system according to claim 12, further comprising:
means for determining a pressure in a fuel gas tank comprising the two-phase fuel gas tank; and
means for determining a temperature in said fuel gas tank.

14. A vehicle comprising a system for determining combustion properties of a two-phase fuel gas, the system comprising:
means for providing the fuel gas from substantially only a first of the two phases of the fuel gas to a combustion engine;
means for operating the combustion engine in such a way that a first λ-value is achieved in the combustion process;
means for providing the fuel gas from substantially only a second of the two phases of the fuel gas to a combustion engine, wherein the second phase is different from the first phase and wherein a same volumetric air/fuel ratio is kept as when the combustion engine was operated to achieve the first λ-value for the first phase of the fuel gas;
means for determining a second λ-value when the combustion engine is operated with the fuel gas from substantially only the second of the two phases of the fuel gas; and
means for determining at least one first combustion property of the fuel gas based at least on said second λ-value.

15. (canceled)

16. (canceled)

17. A computer program product comprising computer program code stored on a non-transitory computer-readable medium, said computer program product used determining combustion properties of a two-phase fuel gas, said computer program code comprising computer instructions to cause one or more control units to perform the following operations:
providing the fuel gas from substantially only a first of the two phases of the fuel gas to a combustion engine;
operating the combustion engine in such a way that a first λ-value is achieved in the combustion process;
providing the fuel gas from substantially only a second of the two phases of the fuel gas to a combustion engine, wherein the second phase is different from the first phase and wherein a same volumetric air/fuel ratio is kept as when the combustion engine was operated to achieve the first λ-value for the first phase of the fuel gas;
determining a second λ-value when the combustion engine is operated with the fuel gas from substantially only the second of the two phases of the fuel gas; and
determining at least one first combustion property of the fuel gas based at least on said second λ-value.
